(19) United States
(12) Patent Application Publication
(10) Pub. No.: US 2021/0194248 A1
(43) Pub. Date: Jun. 24, 2021

(54) Systems, Subsystems, And Methods With Net Energy Metering

(71) Applicant: CE+T Group SA, 4020 Wandre (BE)

(72) Inventors: Eric Martina, Round Rock, TX (US); Guy Michael Barron, Austin, TX (US); Andrew Brian Young, Oakland, CA (US); Uwe Uhmeyer, Austin, TX (US)

(73) Assignee: CE+T Group SA, 4020 Wandre (BE)

(21) Appl. No.: 16/907,289

(22) Filed: Jun. 21, 2020

Related U.S. Application Data
(63) Continuation of application No. PCT/US18/67558, filed on Dec. 26, 2018.
(60) Provisional application No. 62/610,107, filed on Dec. 22, 2017.
(60) Provisional application No. 62/655,758, filed on Apr. 10, 2018.
(60) Provisional application No. 62/658,912, filed on Apr. 17, 2018.

(51) Int. Cl. H02J 3/38; H02J 3/32; H02J 1/10

(52) U.S. Cl. CPC H02J 3/381; H02J 3/32; H02J 2310/12; H02J 2300/26; H02J 1/102

(57) ABSTRACT

In distributed green-energy architectures, where a customer location has energy storage as well as local generation, the present application provides techniques which advantageously prevent the battery from being charged from the grid. This is preferably implemented by using voltage-level signaling to limit power transfer from grid to battery, thereby 1) allowing transfer from PV to battery, and 2) preventing “round-trip” transfer of net energy from grid to battery to grid. This is particularly advantageous where net energy metering is allowed, or where any analogous form of preferential pricing is given to green energy (or to solar energy specifically).

### CROSS-REFERENCE

Priority is claimed from U.S. 62/610,107 filed Dec. 22, 2017, which is hereby incorporated by reference. Priority is also claimed, where available, from U.S. 62/655,758 filed Apr. 10, 2018 and U.S. 62/658,912 filed Apr. 17, 2018, both of which are also hereby incorporated by reference.

### BACKGROUND

The present application relates to electric power systems with net energy metering or the like, and more particularly to separation of green power from stored grid power.

Note that the points discussed below may reflect the hindsight gained from the disclosed inventions, and are not necessarily admitted to be prior art.

### Net Energy Metering

Net energy metering (NEM) is an electrical power billing requirement, in some states and some countries, which allows consumers who generate some or all of their own electricity to get credit for power which they feed back into the utility grid. This is particularly important with renewable energy sources such as wind and solar, which are non-dispatchable. Typically net energy metering uses a bi-directional meter and can measure current flowing to or from the utility grid. In many locations net metering is specifically intended to encourage use of green energy sources, and generated power is credited at the full retail rate. This is, in effect, a subsidy for distributed green generation.

In some places electricity pricing is varied by time-of-day, to add a premium at times of peak demand. However, this has raised some further concerns.

Users with green energy generation will typically also have a battery bank onsite to buffer supply variations. One concern about net metering relates to battery storage by net metering customers: utilities do not want users to store grid energy and then sell it back to the utility. In particular, since net metering policies are intended to encourage local generation of “green” energy, utilities object to repurchasing the non-green (or “brown”) energy which they have supplied. This is particularly a concern where time-of-day pricing is used, since utilities do not want to pay a peak-period premium for energy which has merely been buffered in a user's battery bank.

Standards have therefore been proposed to preclude users from “arbitraging” grid energy to sell back into the grid. This application describes systems and methods which are able to block such resale.

There are other systems which take account of locally generated net power surpluses, and the claimed inventions here are not strictly limited to systems which are labelled as “net metering.” The disclosed inventions can also be advantageously applied to various successor tariffs, or to alternative schemes where it is undesirable for stored grid energy to be fed back into the grid for credit.

### Systems, Subsystems, and Methods with Net Energy Metering

In distributed green-energy architectures, where a customer location has energy storage as well as local generation, the present application provides techniques which advantageously prevent the battery from being charged from the grid. This is preferably implemented by using voltage-level signaling to limit power transfer from grid to battery, thereby 1) allowing transfer from PV to battery, and 2) preventing “round-trip” transfer of net energy from grid to battery to grid. This is particularly advantageous where net energy metering is allowed, or where any analogous form of preferential pricing is given to green energy (or to solar energy specifically).

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows a local subsystem in which the disclosed inventions are implemented.

FIG. 2 is a markup of the system diagram of FIG. 1, showing allowed power flows in a first mode.

FIG. 3 is another markup of the system diagram of FIG. 1, showing allowed power flows in a first mode.

FIG. 4 is a flow chart, showing how the power conversion system of FIG. 1 transitions from active to standby mode.

FIG. 5 is a flow chart, showing how the power conversion system of FIG. 1 transitions from standby to active mode.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The system and methods described here ensure that the battery bank (e.g. Avalon Battery AFB2X of the NX Fusion Plus system) never accrues NEM credits. A non-NEM compliant battery could theoretically charge from the grid, store that grid energy for a period of time, then discharge the stored grid energy at a later time, thereby running a utility meter “backwards” and accruing NEM credits. Under NEM requirements, this scenario must be prevented from ever happening.

In the disclosed implementation, the battery is restricted from charging from the grid. This implementation uses an Avalon Battery AFB2X battery in combination with a “NX model” Ideal Power Converter (PCS) that only allows the battery to be charged from a renewable generator (specifically photovoltaic) and not the grid. This solution ensures all energy discharged from the battery and exported to the grid could have only originated from a renewable generator and is NEM compliant.

System Description

The overall system has four major elements.

1) Ideal Power Model NX Power Conversion System (PCS). This is a unique model designed to ensure Net Energy Metering (NEM) compliant function. The PCS has three ports, including a single three-phase 480 VAC grid tied port and two DC ports separately connect to the photovoltaic (PV) Array and to the battery DC bus. The battery DC bus supports bi-directional power flow.

2) Photovoltaic Array (PV). PV source that provides a renewable unidirectional DC power source to the PCS.

3) Avalon Battery AFB2X Flow Battery (AFB). Each flow battery is composed of low voltage flow batteries that interface to the high voltage battery DC bus through a bi-directional DC-DC converter that supports charging and discharging of the batteries. The auxiliary loads of the battery system including pumps, fans and battery management system (BMS) are supplied by a power supply (a unit-directional DC-DC converter) that is connected in parallel to the bi-directional DC-DC converter. Multiple flow battery systems can be configured in parallel to increase the capacity on the battery DC bus.

4) Energy Management System (EMS). The EMS coordinates the operation of the AFB and PCS. This includes communicating system operating modes and applicable limits.

The present inventions cover inter alia use of voltage-level signaling to limit power transfer from grid to battery, thereby 1) allowing transfer from PV to battery, and 2) preventing “round-trip” transfer of net energy from grid to battery to grid.

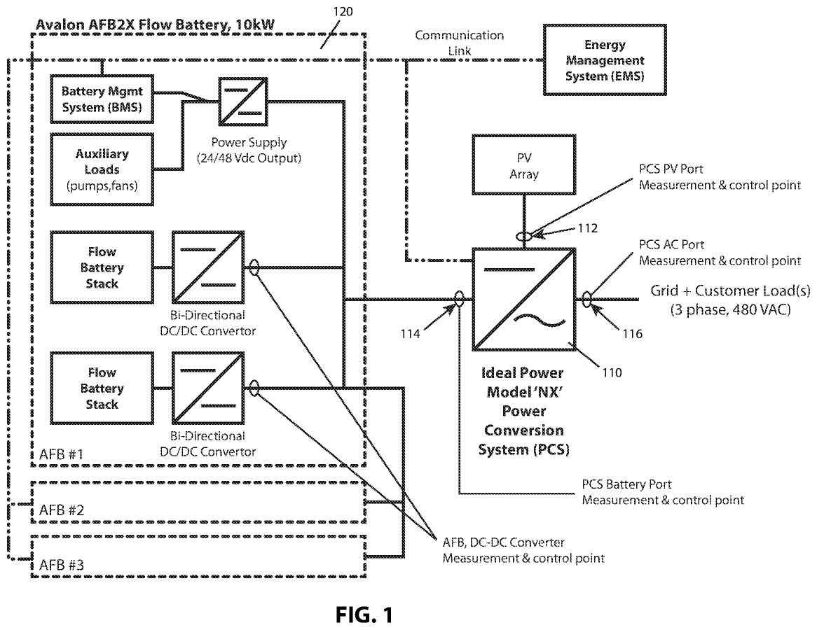

FIG. 1 schematically shows a local subsystem in which the disclosed inventions are implemented. A three-port power converter 110 has a DC port 112 connected to a photovoltaic array, another DC port 114 connected to a battery bank 120, and an AC port 116 connected to the grid and to customer loads. The converter 110 is preferably a modified version of the 30C3 converter from Ideal Power, with modifications as described below. The battery bank 120 can be, as shown in this example, a combination of flow battery modules (e.g. Avalon AFB2X, with integral battery management modules); but alternatively, other battery configurations can be used. Preferably an Energy Management System EMS provides high-level coordination of the battery management modules and the converter 110.

System Operation Modes

There are three modes to consider: Active, Standby and Idle.

1) Active mode Active mode is defined as an operating mode that allows energy to be transferred from the system to the AC grid (export). Energy transferred to the grid can be sourced from either the PV or the battery. Additionally, the battery may be charged in this mode, but only from the DC-coupled PV. Energy is not allowed to flow from the AC grid to the system (import) in this mode thereby ensuring the battery does not charge from the AC grid. This restriction is a function embedded within PCS, achieved by continuously monitoring the power flow on the AC port and automatically transitioning to Standby mode any time this power flow approaches the reverse or import direction.

The typical sequence of events in this mode are as follows:

a. During sunlight hours the PV array will provide power to the PCS PV port.

b. Power from the PV port is distributed between the AC port (export to the grid) and Battery port. Power to or from the battery is based upon set-points provided by the EMS, constrained by the hard-coded limits of the PCS and battery.

c. PCS continually monitors power on the AC port and will limit the power to be export only (energy flows from system to AC grid) between 0 kW and rated kW (15 or 30 kW depending on nameplate rating).

d. If the AC port power exceeds rated kW, the PCS will first throttle the PV back. If PV is fully throttled (i.e. 0 kW) and AC port is still greater than rated kW as a result of the battery discharge, the PCS will fault. e. If PCS detects that the AC port is attempting to import power either due to a reduction in PV production (e.g. cloud cover) or because of an EMS command that attempts to charge battery at power level greater than current PV production, it will immediately transition to Standby mode.

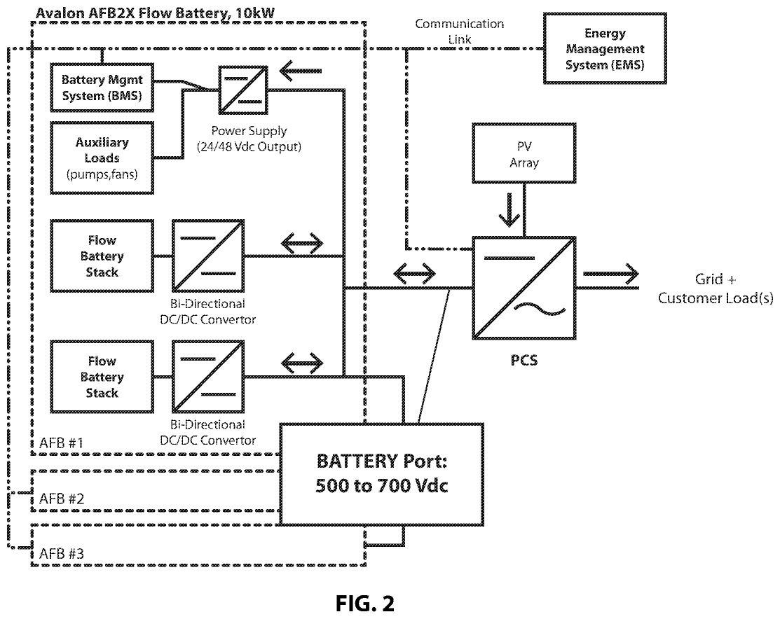

FIG. 2 is a markup of the system diagram of FIG. 1, showing Allowed power flows in this mode. (Specifically, when the PV power source is active AND the voltage of the battery bank is in the range of 500V-700V, export of power to the grid is permitted.)

2) Standby mode Standby mode is an operating mode where the system prevents charging of the battery, to ensure the battery is only capable of being charged from a NEM-compliant generator (i.e. PV) and never charged from the AC grid. In this mode, the PCS controls the voltage applied to the battery to a level that is below the minimum required for the DC-DC converters of the AFB to allow charging of the battery. Voltage levels in both the PCS and AFB are hard-coded within the firmware of component.

In this mode, energy may flow from the PV or the battery to the AC grid. Transition into Standby mode occurs automatically as a result of the PCS detecting AC port attempting to import power in Active mode. Transition out of Standby mode and back into Active mode is also handled directly by the PCS but requires the AC port to return to a minimum export condition for minimum duration, aka clearing time, a hard-coded limit set to a minimum time (at least 60 seconds).

The typical sequence of events in this mode are as follows:

a. Upon transition to this mode the PCS will regulate the voltage on the Battery port. A target voltage set-point will be controlled by the PCS.

b. The voltage set-point will be restricted by the PCS firmware to a value below the Minimum Turn-On Level (MTOL) of the charge mode of the DC-DC converters of the AFB2X. At this level, the battery will be able to only discharge. Auxiliary loads will remain powered in this mode.

c. Upon return of PV production or an EMS request to discharge battery, the PCS will detect a minimum export power at the AC port and after a minimum clearing time, transition back into Active mode.

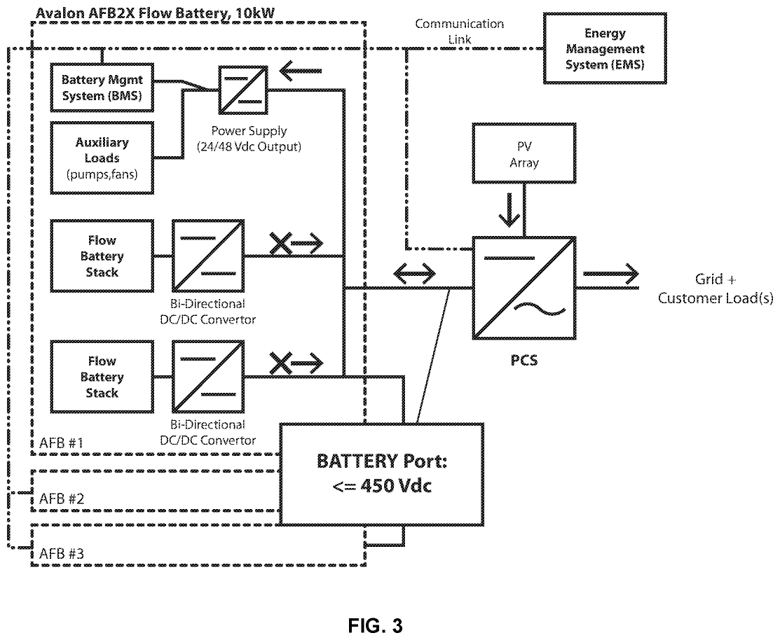

Allowed power flows in this mode are shown in FIG. 3. This is another markup of the system diagram of FIG. 1, showing how, when the PV power source is not active AND the voltage of the battery bank is below 450V, export of power to the grid is blocked.

3) Idle mode Idle mode is a mode in which the ports of the PCS are in an idle state, such that power flow in any direction on all ports of the PCS is disabled by the internal control of the PCS. This mode is equivalent to an off state. Transition to and from this mode is a result of a command from the EMS.

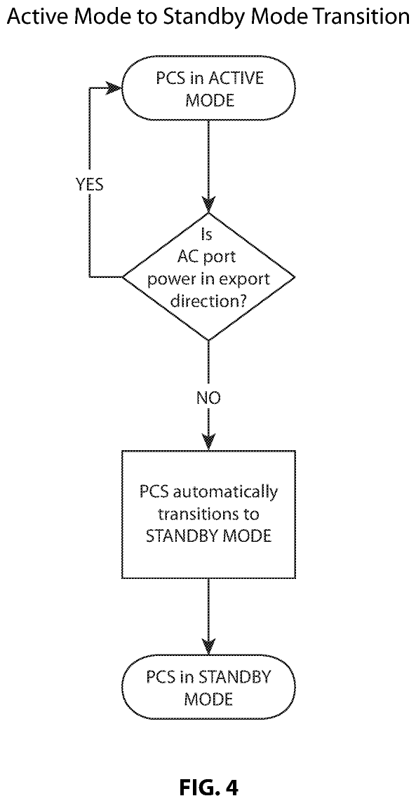

FIG. 4 is a flow chart, showing how the power conversion system of FIG. 1 transitions from active to standby mode.

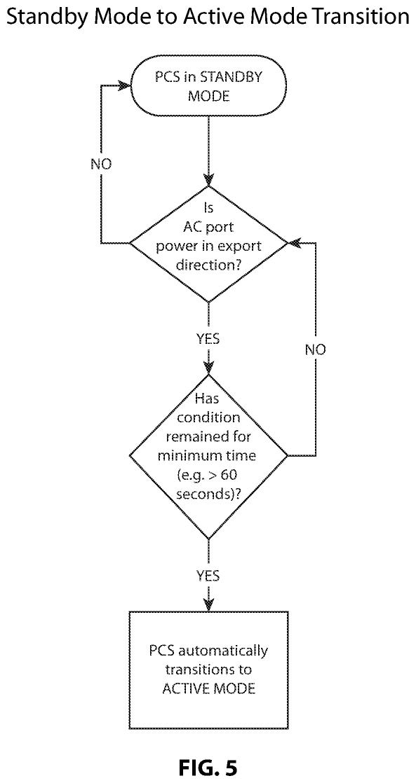

FIG. 5 similarly shows how the power conversion system of FIG. 1 transitions from standby to active mode.

Proposed NEM Compliance Tests

To further illustrate the details of this implementation, following are a set of proposed tests to the system and the components of the system to ensure that NEM rules are adhered to.

Test 1—PCS Automatically Limits Battery Port Voltage Upon Attempt to Import AC Power

Test Description: This test will be conducted on the PCS itself and will be conducted to confirm that upon any attempt to import power at the AC port will immediately result in the DC voltage on Battery port being limited to 450 Vdc. This condition is to remain indefinitely until the power at AC port returns to an export condition, with some offset to account for any hysteresis. This test is expected to be conducted following the UL 1741 certification that is currently in process for the PCS.

Procedure: PCS shall be tested with PV simulator (or power supply) connected to PV port and controllable DC load (or battery simulator) connected to the Battery port. AC port shall be connected to grid simulator. PCS shall start test in Active mode, with PV port in MPPT mode and Battery port at a voltage above 500 Vdc. Power on all ports and voltage on Battery port shall be externally monitored.

At test start, PV simulator shall be set at a value between 0 kW and PCS nameplate rating. Battery load kW (simulating charge) shall be set to a value below PV power such that AC port is exporting power within nameplate rating. Power on PV simulator shall then be reduced at a defined ramp rate until power on AC port approaches zero and attempts to change direction. The DC voltage on the PCS Battery port shall be recorded at this time and the response time shall be recorded. Response time shall be defined as the time between detecting the import power condition on the AC port until the Battery port reaches the desired Standby voltage level.

Test shall be repeated with same setup but this time ramping up the Battery load kW at a desired rate until it exceeds the PV port power. PCS Battery port DC voltage and response time shall again be recorded.

In each test, the parameters shall be held in the “import” state for a minimum duration of 10 minutes following the Battery port transition to ensure the PCS remains in the same state.

Test shall be repeated in each direction at a minimum of three ramps rates (e.g. 0.1 kW/s, 1 kW/s, 5 kW/s). Key results to be recorded, including tolerances are as follows:
AC port power level at time of transition,
Response time, and
Battery port DC voltage.

Test 2—AFB Minimum Charge Voltage

Test Description: This test will be conducted on the AFB itself to confirm it cannot be charged at or below a defined minimum voltage (500 Vdc) in any condition. This minimum level for charging will ensure that the AFB cannot be charged by the PCS while in Standby mode, as verified in Test 1. This test is expected to be conducted following the UL 1973 certification that is currently in process for the AFB.

Test Procedure: The AFB shall be connected to a DC power supply that is capable of charging the battery within its nameplate limits (10 kW) and controlling voltage between 400 and 600 Vdc. Battery shall also be connected to an external control interface (e.g. laptop running a manual EMS interface) to simulate power commands from EMS. Voltage and charging current will be continuously monitored to verify when at what voltage level the charging is stopped.

Battery shall be commanded to charge at nameplate power (10 kW) and DC voltage on power supply set to 50 Vdc above minimum voltage (500 Vdc). Voltage of power supply shall then be ramped down at a defined rate until charge current is halted. Voltage level shall be recorded and that level shall be held for at least 10 minutes to ensure battery does not allow charging to restart after any amount of time.

Test shall be repeated, with power supply voltage starting at 50 Vdc below minimum charge voltage (500 Vdc). Battery shall again be commanded to charge at nameplate power (10 kW). Voltage shall be ramped up at a defined rate until charging current is detected and the voltage level at this point shall be recorded.

Test shall be repeated at a minimum of three ramp rates (e.g. 10 V/s, 50 V/s, and 100 V/s) and at a minimum of three different charge power levels (10%, 50%, and 100% nameplate power).

Key results to be recorded, including tolerances are as follows:
Minimum voltage for AFB charging

Test 3—UL to Confirm that Only the OEM can Change the Firmware, and any UL Certifications are Lost if Firmware is Modified.

UL shall provide formal documentation that certification of individual components, including PCS, battery and DC-DC converter of battery are associated with specific firmware build for each component.

Test 4—Confirm that EMS can Never Override the PCS Firmware Test Description:

Test Description: This test shall require the PCS and AFB of NX Fusion Plus system, in addition to the EMS. In this test, the EMS shall provide commands to the PCS and battery in effort to get the hardware to override the hard-coded restrictions and allow charging of the battery from the AC grid. This test is expected to be conducted following the UL 9540 certification that is current in process for this system.

Test Procedure: This test shall comprise a number of scenarios to be tested, requiring the PCS, AFB and EMS. To complete testing, all components, including a PV array or simulator shall also be connected to the PCS. To verify pass or fail criteria, the AC port and Battery port power shall be continuously monitored. Evaluation criteria is confirming that battery charging does not occur anytime the AC port is import power from the AC grid. Specific scenarios to evaluate include:

4.1 EMS requests PCS IDLE state and then sends request for battery to charge

4.2 EMS requests battery to charge at power greater than current PV output

Test 5—Intermittent PV Supply

Test Description: The purpose of this test is to verify that intermittent PV supply (say, due to cloud cover) does not “break” the system, and that the battery never charges from the grid as a result of fluctuating PV power. This test should be conducted with PCS, AFB and a PV simulator or power supply; likely following the testing and using a similar setup as described in test 4. Test Procedure: The PCS shall be connected to both the AFB and a PV simulator for this test. An EMS shall also be required to request the battery to charge while the PV output is varied to simulate intermittent PV output. Power at the three ports (PV, Battery and AC) shall be monitored continuously.

Battery shall be commanded to charge by EMS at 50% of nameplate power and PV simulator shall be set to a variable output such that it initially starts at a value above the present battery charging power to ensure AC port is in export direction. PV simulator shall then be ramped down at a defined rate below the present battery charge power level such that the AC power approaches import. The power level of the AC port and response time for when the charging ceases shall be recorded. Once the battery stops charging, the AC port will return to export mode and battery will attempt to restart charging once the minimum clearing time has occurred. PV shall again be kept at the same level to ensure the battery does not start charging at this point. AC port power should be monitored and the level at which the battery again ceases to charge shall be recorded. Finally the PV simulator output shall be ramped up at the same rate to a level above the current battery charge request and charging should commence once clearing time has occurred.

Test shall be repeated at a minimum of three PV ramps rates (e.g. 0.1 kW/s, 1 kW/s, 5 kW/s). Key results to be recorded, including tolerances are as follows:
AC port power level at time of transition
Response time

### NX15 Power Core Addendum

The following describes how the presently preferred implementation differs from the standard architecture of the Ideal Power 30C3 power converter. Please refer to the 30C Power Core FPGA Architecture document, which is attached hereto as Appendix A and hereby incorporated by reference, for more detailed information about the 30C firmware architecture. This document should be used in conjunction with other product documentation provided by Ideal Power (“IPWR”), which is referenced throughout this document.

This document describes the implementation strategy to satisfy the Product Requirements Document defined for the NX15, appended herewith as Appendix B and hereby incorporated by reference, as part of the Net Energy Metering (NEM) version of the 30C3 product. The initial product offering will be referred to herein as “NX15”, and will be based on a 30C3 base product, but with specific firmware that implements the Net Energy Metering requirements described in the PRD.

The implementation strategy detailed in this document will be divided into three areas. Each of these areas will be discussed in detail in the following sections.

1. Fulfilling NEM functional requirements.

2. Protection against system risks, including safety issues and NEM circumvention.

3. Impact on procedures, including POST, factory test, field updates, etc.

The information about system risks may need to be incorporated into an updated UL 1998 Risk Analysis document.

Models and Model Names

This document addresses implementation of a specific product model for NEXTracker, that implements Net Energy Metering (NEM) functionality. In general, NEXTracker specific models will have a model name using a format of “NXYY_NEM”, where NX refers to NEXTracker, YY refers to the AC port nameplate rating in kilowatts, and the optional _NEM suffix indicates implementation of the NEM functionality.

Thus, NX15_NEM is a product model with an AC port limited to 15 kW that implements the NEM functionality. For convenience, throughout this document, the term “NX15” will be used, although the correct full model name is understood to be NX15_NEM.

Implementation strategy described herein shall be equally applicable to similar product models with different AC nameplate ratings (e.g. NX18_NEM or NX30_NEM). Such other similar product models will have unique firmware images and checksums, but will incorporate similar functionality otherwise.

Fulfilling NEM Functional Requirements

Net Energy Metering (NEM) constraints will be met collectively by a system of components. These components are independently certified with respect to various safety standards (e.g. UL1741SA for the 30C3/NX15 component). The system of components will also be certified to meet the NEM constraints as an overall system.

The overall system has four major elements.

1) Ideal Power NX15 Power Conversion System (PCS). Interconnection point between the grid, PV, and battery components.

2) Photovoltaic Array (PV). PV energy resource that provides DC power directly to the PCS.

3) Avalon Battery AFB2X Flow Battery (AFB). Each flow battery is composed of voltage flow batteries that interface to the high voltage battery DC bus through a bi-directional DC-DC converter that supports charging and discharging of the batteries. The auxiliary loads of the battery system including pumps, fans and battery management system (BMS) are supplied by a power supply (a unit-directional DC-DC converter) that is connected in parallel to the bi-directional DC-DC converter. Multiple flow battery systems can be configured in parallel to increase the capacity on the battery DC bus.

4) Energy Management System (EMS). The EMS coordinates the operation of the AFB and PCS. This includes communicating system operating modes and applicable limits.

### Modes of Operation

To satisfy NEM functional requirements, the NX15 PCS shall:
a. Have three modes of operation: OFFLINE, ACTIVE, and STANDBY;
b. Be responsible for switching between ACTIVE and STANDBY modes as described below;
c. Return to OFFLINE mode in the event of a fault condition; and
d. Provide a configurable option for either manual or automatic startup control.

Note that the use of “OFFLINE” versus “IDLE” is a conscious deviation from the PRD to distinguish this operating mode from the port method by the same name. This will help eliminate ambiguity in the documentation, and improve code readability in the firmware source code.

For each mode of operation, all three of the PCS ports must utilize an appropriate control method, which will be strictly enforced by the PCS firmware. The port methods required are IDLE, NET, MPPT, and NEM. Note that the IDLE, NET, and MPPT methods are the standard methods previously defined for the 30C3 with only minor changes. The NEM method is a newly defined method specific to the NEM enabled models, and is an updated version of the previously defined DC VOLTS method, but with automatic management of the voltage setpoint and ramping features.

The methods for each of the PCS ports during each mode of operation is shown below.

| Mode | Port AC1 | Port DC2 | Port DC3 | Notes |
|---|---|---|---|---|
| OFFLINE | IDLE | IDLE | IDLE | No power flow, |
| | | | | unit is off |
| STANDBY | NET (bi- | NEM (voltage | MPPT | Power can be |
| | directional) | set to ~425 | | imported from |
| | | Vdc) | | the grid to |
| | | | | run battery |
| | | | | maintenance |
| | | | | functions only. |
| ACTIVE | NET (export | NEM (voltage | MPPT | AC port is |
| | only) | set to ~525 | | export only. |
| | | Vdc) | | |

The NET and NEM methods will require slightly different behavior based on the current mode of operation, as noted above. To help support these behaviors, the system management module will need to define two additional global register bits as follows:

NEM_ena—this will be a simple flag indicating the NEM constraints are to be enforced within the PCS firmware. In a standard build (for use during development), this register bit will be configurable through the normal HCR access protocol. In the final NEM firmware build, this register bit will be hard-wired true, such that all relevant NEM features are always enabled.

NEM_mode—this is a single bit register which distinguishes between the ACTIVE (1) and STANDBY (0) operating modes in an NEM compliant system.

These bits shall be returned in the system_op_mode register (HCR 267), in bits 8 and 9 respectively. During development, the NEM_ena bit will be a R/W bit. In the final NEM build, this bit will be forced to a value of ‘1’. The NEM_mode bit will always reflect the status of an internal FSM that manages the transitions between ACTIVE and STANDBY operating modes.

During development, additional control (such as setting the AC nameplate power limit or hysteresis timing) can be applied through unused register 395 (e.g. NEM_control), and adjustment of the port 2 voltages can be managed via values in unused registers 398 and 399 (e.g. NEM_low_volts and NEM_high_volts). These voltage setpoint registers will use the typical 0.25V scale. All of these values will be hard coded in the final build, and these registers can revert to unused reserved registers in the final build.

### Transitions Between Modes of Operation

A small FSM will be needed to manage the NEM_mode bit and provide overall transition control between the ACTIVE and STANDBY operating modes while incorporating appropriate hysteresis parameters.

The NEM_mode bit will be asserted while in the ACTIVE state, and deasserted during either STANDBY or OFFLINE operating modes. STANDBY and OFFLINE are easily distinguished by other status bits in the system_status and port_status registers.

When the system starts (either manually or automatically), the operating mode will transition from OFFLINE to STANDBY.

A transition from STANDBY to ACTIVE requires that both the PV power imported and the AC power exported exceed 1000 watts for 60 seconds. Note, this is a conscious deviation from the PRD to eliminate potential of oscillating operating modes while PV is inactive.

A transition from ACTIVE to STANDBY occurs whenever the AC power exported drops below 500 watts.

Method Changes and Behaviors

The standard MPPT method does not need any modifications. This method can be run as-is on the DC3 port connected to the PV. This method will attempt to derive maximum import power from the PV whenever the system is not OFFLINE, but will still honor soft limits and NET power pushback requests as needed.

The NEM method used for the AFB interface on the DC2 port will be an updated version of the previously defined DC VOLTS method, but with automatic management of the voltage setpoint and ramping features. When NEM_mode is deasserted (OFFLINE or STANDBY modes), the voltage setpoint will be set to the NEM_low_volts value, and the port voltage will ramp to that value. When NEM_mode is asserted (ACTIVE mode), the voltage setpoint will be set to the NEM_high_volts value, and the DC voltage will ramp to that value. Managing the voltage setpoint as a function of the NEM_mode bit is the only change needed for this method. Setting the voltage limit for this port to NEM_high_volts+50V is recommended during setup, but is not automatically performed by this method.

The NET method used for the grid interface on the AC port requires several modifications. This first set of changes involves the soft power limits on import and export. When NEM_mode is deasserted (OFFLINE or STANDBY modes), the export real power limit is set to the AC nameplate value of 15 kW, while the import real power limit is set to 200 W (TBD) to provide minimal power for auxiliary loads such as pumps, fans, and BMS. When NEM_mode is asserted (ACTIVE mode), the export real power limit remains set to the AC nameplate value of 15 kW, while the import power limit is set to 0. Thus, in the ACTIVE mode, the auxiliary loads must be completely supported by PV.

The second set of changes for the NET method are related to the NET power pushback feature, which will be required to support the soft power limits noted previously. Soft limits on the NET power port are normally supported by pushing back on another port that is presumably not yet limited. The changes needed for this application are summarized in the following table:

| Operating | | | Result or Fault |
|---|---|---|---|
| Mode | Soft Limit Violated | Fault | Explanation |
| ACTIVE | AC export (15 kW) | No | Pushback on DC3 (PV |
| | | | import will be reduced) |
| ACTIVE | AC Import (0) | Yes | Battery charge greater than |
| | | | PV resource |
| STANDBY | AC Export (15 kW) | Yes | Excessive battery discharge |
| STANDBY | AC Import (200 kW) | Yes | Excessive battery charge |

Note that the faults listed above should all be prevented by correct operation of the EMS/BMS controls. The one possible exception to this is a sudden reduction in the PV import which might exceed the response of the system as it transitions from ACTIVE to STANDBY, which should occur as the AC export goes below 500 W. If the system responds sufficiently fast, then the AC soft import limit of OW should not be violated.

The NET power pushback feature would normally attempt to pushback during all of the scenarios listed in the table above. However, for the cases listed as Faults above, the PV is not providing power to pushback against. Nor is pushing back against DC2 an option, as the AFB acts as a current sink/source, and is not directly controllable by the PCS. So, for these cases, the NET method will need to provide an additional flag(s) to the fault handler indicating the fault, and thus taking the system down to the OFFLINE mode. The fault handler will include these fault sources in the TBD fault definition (Method?).

Protection Against System Risks

System Risks in this context refers to circumstances that could lead to either safety issues or circumvention of the NEM requirements at a system level. This section will identify these risks and discuss their possible mitigation. Not all System Risks included in this section may be possible given the implementation strategy chosen.

System Risks Leading to Safety Issues

Overload of DC2 port-potential for unsafe voltage on DC2 port. Whenever the AFB is discharging, the power discharged is added to the PCS line capacitors on the DC2 port, with the PCS performing a corresponding import of power. In this situation, the PCS import matches the AFB export, and the DC2 port line capacitor voltage will remain fixed (with some ripple). However, if the PCS faults for any reason, the DC2 port voltage will quickly increase as long as the AFB is still discharging. Voltages>1000V should begin to active the DC2 MOVs, which should provide adequate protection. In addition, the AFB control logic should be optimized for quick response (cessation of export) in response to a high DC voltage.

DC Common shared between PV and AFB-potential for coupling PV GFDI fault to the AFB. The DC2 and DC3 ports share the DC Common terminal, which is in effect the DC-rail for both the PV and AFB components (e.g. they are shorted together at the PCS). In this situation, a PV GFDI fault can effectively short one side of the AFB to ground. The PCS can detect GFDI faults and shutdown (return to OFFLINE) in this case. The AFB control logic should be validated to be safe in this situation.

System Risks Leading to Circumvention of Nem Requirements

Incorrect Firmware Image/Version loaded. The final NEM firmware version will be separately compiled with a unique build version and checksum. Thus, correct firmware should be easily verifiable both locally and remotely (for audit purposes).

Incorrect Soft Power Limits used for AC port. The final NEM firmware version will have hard coded values for the various AC Port soft power limits, which are keyed to the hard coded NEM_ena flag.

Incorrect DC2 voltage setpoints. The final NEM firmware version will have hard coded values for the NEM_high_volts and NEM_low_volts values, which are keyed to the hard coded NEM_ena flag.

License File tampered with. None of the NEM features will be associated with (enabled by) licenses. Instead) all NEM features and behavior will be keyed to the hard coded NEM_ena flag.

Impact on Procedures

Post

Power On Self Test (POST) routines should be largely unaffected by changes for NEM support. When an NX15 powers up, it should still be able to run POST. In cases where AC is present, the extended POST routines for line isolation and AC IGBT functionality should also run successfully. No changes to POST have been identified, but the POST function needs to be verified with the final NEM firmware version.

Factory Test

Factory Test utilizes a number of features that are outside the scope of the NEM requirements. As a result, Factory Test will still need to use the standard certified 30C3 firmware image throughout the manufacturing process up to the point of final configuration.

It is recommended that during final configuration, the base 30C3 product should be updated with the NEM firmware image, thus converting it to an NX15. The update should be validated by applying 24V power, observing POST, verifying FPGA version and checksum, and verifying that the NEM_ena bit is set in the system_op_mode register (bit 8).

A final functional test is optional, but if utilized would require DC sources that mimic the NEXTracker system configuration, and is therefore outside the scope of this document.

Field Updates

All aspects of the 30C3 feature set relating to updating firmware in the field shall remain available to the NX15 (e.g. SDcard directory structure, FTP support, etc.). The NX15 can only be field updated with NEM capable firmware versions that have been appropriately certified and listed. Upgrading the NX15 with any other version of firmware is a violation of product warranty and NEM eligibility.

### Glossary

AFB—Avalon Flow Battery

BMS—Battery Management System

EMS—Energy Management System

FPGA—Field Programmable Gate Array

FSM—Finite State Machine

FW—Finn ware

GFDI—Ground Fault Detection and Interruption

HCR—Hardware Control Register

IGBT—Insulated-Gate Bipolar Transistor

MPPT—Maximum Power Point Tracking

PCS—Power Conversion System

POST—Power On Self Test

PV—Photo-voltaic

Advantages

The disclosed innovations, in various embodiments, provide one or more of at least the following advantages. However, not all of these advantages result from every one of the innovations disclosed, and this list of advantages does not limit the various claimed inventions.
Compliance with Net Energy Metering is assured.
Compatibility with previous and/or external systems is retained.

According to some but not necessarily all embodiments, there is advantageously provided: A method of operating a power system at a particular location, comprising the actions of: when a local green energy source is providing power, transferring power from the green energy source into a three-port power converter through a first port thereof, and accordingly outputting power out through a second port thereof which is operatively connected to battery storage and/or through a third port thereof which is connected to an AC power grid; and when power is flowing into the converter through the third port, setting the voltage of the second port at a value which does not permit the battery storage to reuseably absorb energy.

According to some but not necessarily all embodiments, there is advantageously provided: A method of operating a power system at a particular location, comprising the actions of: when a local green energy source is providing power, transferring power from the green energy source into a three-port power converter through a first port thereof, and accordingly outputting power out through a second port thereof which is operatively connected to battery storage and/or through a third port thereof which is connected to an AC power grid; and when power is flowing into the converter through the third port, preventing power from flowing to the battery storage through the second port.

According to some but not necessarily all embodiments, there is advantageously provided: A method of operating a subsystem which includes both a green energy source and battery storage, comprising the actions of: a) interfacing to the green energy source through a first port of a three-port power converter, interfacing to the battery storage bidirectionally through a second port of the three-port power converter, and interfacing to a utility power grid bidirectionally through a third port of the three-port converter; b) when power is flowing into the converter through the third port, preventing power from flowing to the battery storage from the second port; and c) under some conditions, transferring power from the battery storage into the second port and out through the third port to the utility grid.

According to some but not necessarily all embodiments, there is advantageously provided: A power subsystem comprising: a local green energy source; a three-port power converter; a battery storage bank; wherein a first port of the power converter is connected to receive power from the green energy source, and a second port of the power converter is connected to bidirectionally transfer power to and from the battery bank, and a third port of the power converter is connected to bidirectionally transfer power to and from an AC power grid; and wherein the converter is configured to set the voltage of the second port, when power is flowing into the converter through the third port, at a value which does not permit the battery storage to reuseably absorb energy.

According to some but not necessarily all embodiments, there is advantageously provided: A power subsystem comprising: a local green energy source; a three-port power converter; a battery storage bank; wherein a first port of the power converter is connected to receive power from the green energy source, and a second port of the power converter is connected to bidirectionally transfer power to and from the battery bank, and a third port of the power converter is connected to bidirectionally transfer power to and from an AC power grid; and wherein the converter is configured to prevent the battery storage from charging when power is flowing into the converter through the third port.

According to some but not necessarily all embodiments, there is advantageously provided: techniques which advantageously prevent the battery from being charged from the grid, in distributed green-energy architectures where a customer location has energy storage as well as local generation. This is preferably implemented by using voltage-level signaling to limit power transfer from grid to battery, thereby 1) allowing transfer from PV to battery, and 2) preventing “round-trip” transfer of net energy from grid to battery to grid. This is particularly advantageous where net energy metering is allowed, or where any analogous form of preferential pricing is given to green energy (or to solar energy specifically).

Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In most presently-preferred embodiments, the power conversion is a power packet switching power converter.

In some embodiments, the voltage of the second port is set at a value that does not permit the battery storage to reuseably absorb energy. In other embodiments, this can be different.

In some embodiments, the AC power grid connection is operatively connected to e.g. a North American power grid, such as e.g. the Eastern, Western, Texas, Quebec, or Alaska Interconnection. In other embodiments, this can be different.

In some embodiments, the power grid has a frequency of 60 Hz. In other embodiments, this can be different.

Appendices A and B show exemplary details for a 30C Power Core FPGA Architecture and

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method of operating a power system at a particular location, comprising the actions of:
when a local green energy source is providing power, transferring power from the green energy source into a three-port power converter through a first port thereof, and accordingly outputting power out through a second port thereof which is operatively connected to battery storage and/or through a third port thereof which is connected to an AC power grid; and
when power is flowing into the converter through the third port, setting the voltage of the second port at a value which does not permit the battery storage to reuseably absorb energy.

2. The method of claim 1, wherein the power converter is a power packet switching converter.

3. The method of claim 1, wherein the battery storage comprises flow batteries.

4. The method of claim 1, wherein the green energy source is photovoltaic.

5. The method of claim 1, wherein the AC power grid connection has a frequency of 60 Hz.

6. The method of claim 1, wherein the AC power grid connection is operatively connected to the Eastern Interconnection.

7. A method of operating a power system at a particular location, comprising the actions of:
when a local green energy source is providing power, transferring power from the green energy source into a three-port power converter through a first port thereof, and accordingly outputting power out through a second port thereof which is operatively connected to battery storage and/or through a third port thereof which is connected to an AC power grid; and
when power is flowing into the converter through the third port, preventing power from flowing to the battery storage through the second port.

8. The method of claim 7, wherein the power converter is a power packet switching converter.

9. The method of claim 7, wherein the battery storage comprises flow batteries.

10. The method of claim 7, wherein the green energy source is photovoltaic.

11. The method of claim 7, wherein the AC power grid connection has a frequency of 60 Hz.

12. The method of claim 7, wherein the AC power grid connection is operatively connected to the Western Interconnection.

13. A method of operating a subsystem which includes both a green energy source and battery storage, comprising the actions of:
a) interfacing to the green energy source through a first port of a three-port power converter, interfacing to the battery storage bidirectionally through a second port of the three-port power converter, and interfacing to a utility power grid bidirectionally through a third port of the three-port converter;
b) when power is flowing into the converter through the third port, preventing power from flowing to the battery storage from the second port; and
c) under some conditions, transferring power from the battery storage into the second port and out through the third port to the utility grid.

14. The method of claim 13, wherein the power converter is a power packet switching converter.

15. The method of claim 13, wherein the battery storage comprises flow batteries.

16. The method of claim 13, wherein the green energy source is photovoltaic.

17. The method of claim 13, wherein the AC power grid connection has a frequency of 60 Hz.

18. The method of claim 13, wherein the AC power grid connection is operatively connected to the Texas Interconnection.

19-30. (canceled)
